(19) United States
(12) Patent Application Publication
(10) Pub. No.: US 2010/0299687 A1
(43) Pub. Date: Nov. 25, 2010

(54) PEER-TO-PEER VIDEO CONTENT DISTRIBUTION

(76) Inventor: Adrian Bertino-Clarke, Pasadena, CA (US)

Correspondence Address: JOSEPH SWAN, A PROFESSIONAL CORPORATION, 1334 PARKVIEW AVENUE, SUITE100, MANHATTAN BEACH, CA, 90266, US

(21) Appl. No.: 12/471,352

(22) Filed: May 23, 2009

(51) Int. Cl. H04N 7/16; G06Q 30/00; G06F 15/16; H04N 7/025

(52) U.S. Cl. 725/5; 725/25; 709/204; 725/32; 705/14.4

(57) ABSTRACT

Provided are, among other things, systems, methods and techniques for facilitating the distribution of video content. According to one embodiment, a data-storage device stores computer-executable process steps and data, with: the data including (i) file digests and/or (ii) links to file digests that are located on one or more remote unaffiliated server, the file digests containing information for downloading corresponding files using at least one peer-to-peer network, the corresponding files including both restricted-access sponsored video files and unrestricted files, and the unrestricted files having made available by different participants in at least one peer-to-peer network. In addition, a processor is coupled to the data-storage device and configured to execute the process steps, with the process steps including steps to provide, at a network address on a publicly accessible network, an access site that allows users to locate and download the file digests, with the file digests for the restricted-access sponsored video files being separately visually designated as such on the access site, and each of the restricted-access sponsored video files including an identification of an operator of the site.

### FIELD OF THE INVENTION

The present invention pertains to systems, methods, techniques and apparatuses for distributing, and for facilitating the distribution of, video content over one or more peer-to-peer networks.

### BACKGROUND

Peer-to-peer networks have arisen as an alternative to the more common server-client arrangement on the Internet. In the server-client arrangement, a large number of client devices interact with a single server box or server farm (collectively referred to herein as a server), with most of the content flowing from the server to the individual clients. However, in a peer-to-peer network, each device participating in the network functions as both a server and a client, and there generally is no pre-established pattern of dataflow among the individual devices. Rather, in a peer-to-peer network, each device (or its user) individually determines how much it will utilize the network as a client and, at the same time, how much content it will make available to other devices for downloading.

A variety of different peer-to-peer networks exist on the Internet. For each, the participant devices are required to run a corresponding application that enables it to function as a participant in the peer-to-peer network. Although peer-to-peer networks can be used for many different purposes, probably the most common use today is for file sharing. Such filesharing peer-to-peer networks allow participants to share any kind of file with other participants. In a nutshell, a participant identifies a file that he or she would like to obtain, finds other participants that have a copy of that file, downloads pieces of the file from those participants, and then assembles the pieces into the complete file. Probably the most common peer-to-peer file sharing protocol is bit torrent.

In order to facilitate peer-to-peer file sharing, it is common for a certain amount of initial processing to be performed the first time a file is made available to other participants. Typically, as shown in FIG. 1, a file 10 that is designated (e.g., by the user of the device on which the file 10 is stored) as being available to be shared is first conceptually divided into a number of pieces (such as individual pieces 12). Those pieces typically are of equal length and represent the smallest unit that can be downloaded from a participant. A digest file 15 (called a “torrent” in the bit torrent protocol) is created and populated with information regarding the file 10 and information regarding a tracker site 20. The information regarding file 10 typically includes information about the file 10 as a whole, such as descriptive information that allows participants to determine what the file 10 is, together with information about the pieces 12, such as the size of each piece 12 and a checksum or other error detection and/or correction code for each piece 12 that allows the receiving participant to verify that it has properly received that piece 12. The information regarding tracker site 20 typically includes a link to the site 20.

In this regard, many peer-to-peer file sharing networks use a central “tracker” that maintains current information about which participants are sharing which files. By including a link to the tracker site 20 within the file digest 15, once a participant has obtained the file digest 15, it can contact the tracker site 20, identify the participants that have the desired file 10, contact those participants, and then begin requesting and downloading all of the pieces 12 for the file 10 from them.

Peer-to-peer filesharing networks have many advantages, including the ability to allow participants to easily post content that others can access without the necessity of having available servers that are capable of handling large download demands that might eventually materialize. Unfortunately, these same advantages have caused some to use peer-to-peer networks for illegal distribution of content, mainly distribution of content for which the uploading participants do not have the necessary copyright licenses. Partially as a result of this association to pirated content, there has to date been very little distribution of mainstream content over peer-to-peer filesharing networks.

### SUMMARY OF THE INVENTION

The present invention addresses this problem by, among other things, providing ways in which licensed content can be distributed over one or more peer-to-peer filesharing networks in ways that are beneficial to all involved. For example, the present invention provides systems, methods, apparatuses and techniques through which (1) one or more central sites for accessing digests of files available on one or more peer-to-peer filesharing networks are incentivized to promote the downloading of such licensed content and/or (2) such licensed content can be clearly distinguished from non-licensed content.

Thus, one embodiment of the invention is directed to a system for facilitating the distribution of video content, including a data-storage device stores computer-executable process steps and data, with: the data including (i) file digests and/or (ii) links to file digests that are located on one or more remote unaffiliated server, the file digests containing information for downloading corresponding files using at least one peer-to-peer network, the corresponding files including both restricted-access sponsored video files and unrestricted files, and the unrestricted files having made available by different participants in at least one peer-to-peer network. In addition, a processor is coupled to the data-storage device and configured to execute the process steps, with the process steps including steps to provide, at a network address on a publicly accessible network, an access site that allows users to locate and download the file digests, with the file digests for the restricted-access sponsored video files being separately visually designated as such on the access site, and each of the restricted-access sponsored video files including an identification of an operator of the site.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram illustrating the relationships, in a typical peer-to-peer file sharing network, among a file to be shared, the digest or torrent for the file and the tracker site for the file.

FIG. 2 is a conceptual illustration of one example of a file to be shared according to representative embodiments of the present invention.

FIG. 3 is a block diagram of a system for facilitating the delivery of video content over one or more peer-to-peer file sharing networks according to representative embodiments of the present invention.

FIG. 4 illustrates an example of a site for locating digests pertaining to P2P-shared files.

FIG. 5 illustrates an example of search results returned from a search of available video files.

FIG. 6 is a block diagram showing the initial playing of a downloaded video file on a standard video player according to a representative embodiment of the present invention.

FIG. 7 is a block diagram showing the playing of a downloaded video file on an enhanced video player according to a representative embodiment of the present invention.

FIG. 8 is a flow diagram illustrating an exemplary sequence of events in connection with a requested video-playing operation.

FIG. 9 is a block diagram of a representative system in which a user plays video content according to representative embodiment of the present invention.

FIG. 10 is a block diagram of a management console system used by a sponsored content provider in a representative embodiment of the present invention.

FIGS. 11A-D illustrate a display portion of a user interface for designating overlay advertisement templates through a video preparation process.

FIG. 12 illustrates timelines resulting from an advertisement-designation process.

FIG. 13 illustrates a single frame of video content being played back, with advertisements having been inserted into a previously designed template.

FIG. 14 is a block diagram of a server used by a P2P access provider in a representative embodiment of the present invention.

FIG. 15 is a block diagram of a user device for communicating across a peer-to-peer filesharing network and for interacting with a P2P access provider according to a representative embodiment of the present invention.

FIG. 16 is a block diagram of an advertisement system according to a representative embodiment of the present invention.

### DESCRIPTION OF THE PREFERRED EMBODIMENT(S)

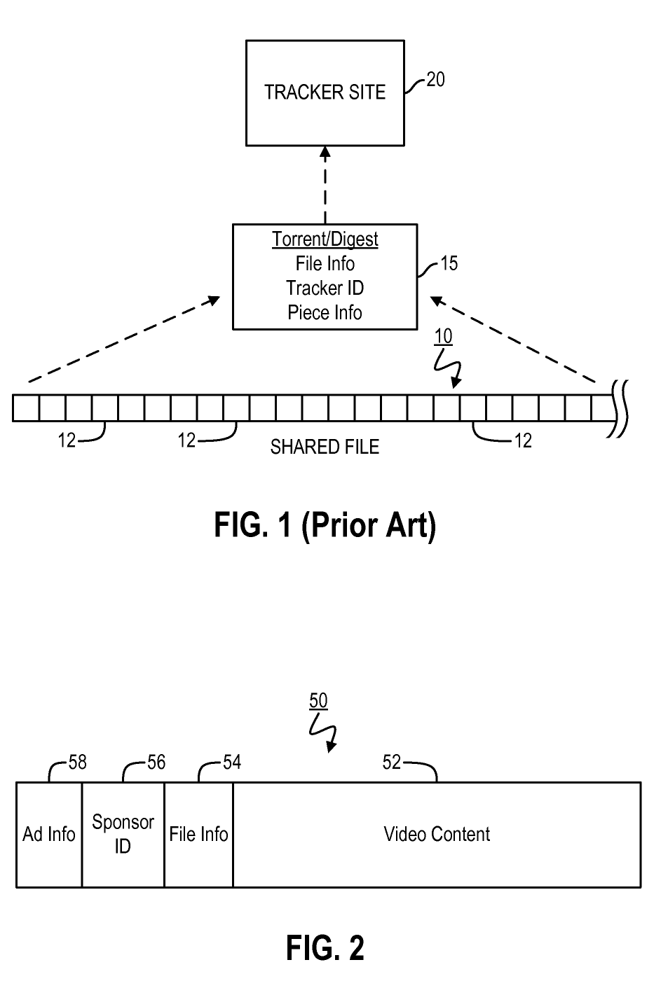

The present invention involves, among other things, the sharing of video content over one or more peer-to-peer (P2P) filesharing networks. In the preferred embodiments, such video content is included in a file that includes information beyond what has been included in the typical file that conventionally has been shared in this manner. As shown in FIG. 2, the preferred video file 50, in addition to the video content 52 and the file information 54 (such as filename and other metadata) that is present in a conventional shared file 10, also includes information 56 identifying a sponsoring site and may include information 58 pertaining to advertisements to be displayed when playing the video content 52.

In the preferred embodiments, the sponsoring site identification information 56 is any code that uniquely identifies the “sponsoring site”. As discussed in more detail below, the sponsoring site could be a tracker site, a search engine site for locating digests for P2P-shared files, or any other site through which a variety of P2P-shared files can be accessed. It is noted that the sponsoring site identification information 56 can be embedded within the file identifier, e.g., by using a different file identifier for each different video file 50 that is to be sponsored by a different site, even if such different video files 50 have identical video content 52.

The advertisement information 58 preferably includes at least a template for indicating how, where and/or when advertisements will be displayed during the playing of the video content and/or a pointer to actual advertisement content to be inserted or displayed during such playing. However, in alternate embodiments any or all of such advertisement information can be stored in a separate file. Additional detail regarding advertisement information, as well as its incorporation and use, is discussed in more detail below.

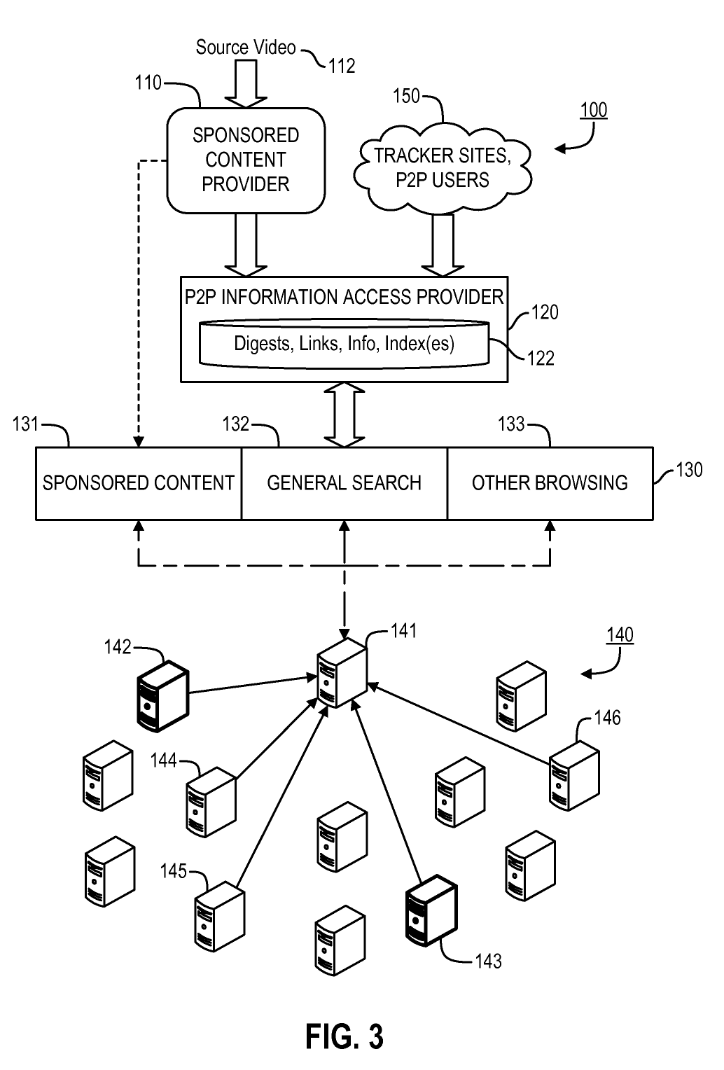

FIG. 3 is a block diagram of a system 100 for facilitating the delivery of video content over one or more peer-to-peer file sharing networks according to representative embodiments of the present invention. In this system 100, a sponsored content provider 110 cooperates with a peer-to-peer information access provider 120 to provide access to digests 15 for corresponding to sponsored P2P-shared files. Although only a single sponsored content provider 110 is shown in FIG. 3, in certain embodiments of multiple different sponsored content providers 110 will be initially making available content that is sponsored by P2P access provider 120. Similarly, any individual sponsored content provider 110 may have an arrangement with multiple different P2P access providers 120 whereby such P2P access providers 120 sponsor the same content that is initially made available by such sponsored content provider 110.

In the preferred embodiments, P2P access provider 120 makes available a site 130 (e.g., a website if the site 130 is provided over the Internet) through which individuals can locate P2P-shared files 50 (as well as other files 10) that they would like to download. Accordingly, P2P access provider 120 preferably provides browsing and searching capabilities for various digests 15 through its website 130. It is noted that P2P access provider 120 preferably provides access to both restricted-access sponsored video files (e.g., from provider 110) and unrestricted files (e.g., from a variety of other sources, such as participants in one or more peer-to-peer networks). In the preferred embodiments, restricted-access files are files incorporating technology limiting the ability to play them back, such as digital rights management (DRM) technologies, proprietary-format technologies, watermark technologies and/or encryption-based technologies.

P2P access provider 120 can, depending upon the embodiment, also provide tracking functionality for some of the shared files 10. In such a case, the digest-location services provided by P2P access provider 120 need not be limited to digests 15 corresponding to the files 10 that it tracks. Instead, again depending upon the embodiment, P2P access provider 120 can offer digest-location services with respect to files that it tracks and/or files that others track.

As shown in FIG. 3, site 130 preferably includes different portions. One such portion 131 displays, and allows an individual to browse, and digests 15 for and information pertaining to content that is sponsored by P2P access provider 120, e.g., in addition to any other content from any other sponsored content providers 110 (not shown in FIG. 3), that it has agreed to sponsor. Another portion 132 allows individuals to locate digests 15 by executing term searches (e.g., Boolean or natural language) or, in some cases, image, audio and/or video searches. Another portion 133 permits browsing through digests 15 pertaining to non-sponsored content.

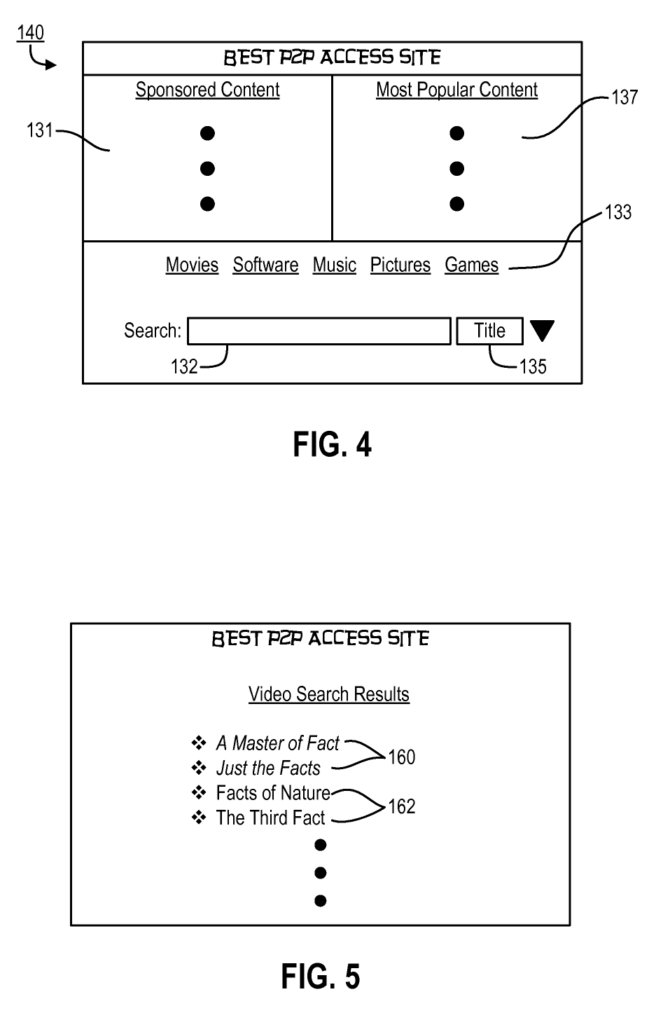

An example of a page 140 from such a site 130 is shown in FIG. 4. Here, site 130 is implemented as a website, and page 140 includes all three portions of 131-133. In the present embodiment, portion 131 lists information for some of the digests 15 of the sponsored content, such as digests 15 pertaining to very popular content that is intended to entice the client to link to one or more additional pages containing descriptions of digests 15 for additional sponsored content and/or additional detail regarding the sponsored content 131 shown on page 140. Portion 132 permits a client to perform a textual term search in any field selected from drop-down menu 135. Portion 133 permits the client to link to different pages highlighting digests 15 for correspondingly different types of non-sponsored content (e.g., movies, software, music, pictures, games, with each such page potentially also permitting similar searching within the corresponding non-sponsored content type). Finally, an additional portion 137 displays a list of the most popular digests 15, potentially pertaining to both sponsored content and non-sponsored content, with the information regarding the sponsored content visually distinguished from the information regarding the non-sponsored content.

In the foregoing embodiment, digests 15 corresponding to sponsored content 131 are visually distinguished from digests 15 corresponding to non-sponsored content by being located within distinct portions of a single webpage 140 and/or by being located on entirely different pages or sets of pages. This visual distinction is preferred in order to clearly convey to the users of the site 130 which digests 15 correspond to sponsored content. For example, through the act of sponsoring particular content, the P2P access provider 120 typically will be understood to be vouching for the integrity of the corresponding files (e.g., with respect to intellectual property rights and/or freedom from computer viruses or other malicious software code). Therefore, it generally is desirable to clearly highlight such sponsored content. At the same time, the sponsored content provider(s) 110 typically will want to clearly distinguish their content from any non-sponsored content (and possibly from other sponsored content from other providers 110) to avoid any legal or perceptual taint that might be associated with such other content.

Thus, it generally is desirable to separate digests 15 for, and other information pertaining to, sponsored as opposed to non-sponsored content, as much as possible on the site of 130. Various approaches can be used to achieve this goal. As in the previous embodiment, it is possible to include both kinds of content only in the home page and, even then, only in clearly distinct regions of the home page 140. After that, the user of the site 130 must choose to link either to the sponsored content portion of the site (listing only sponsored content) or to the non-sponsored content of the site (listing only non-sponsored content). An even more restrictive approach is to prevent any listing of sponsored and non-sponsored content on the same page, e.g., instead including just a simple link to each such portion on the home page. In addition, different pages (or sets of pages) can be provided on the sponsored-content portion of the site 134 different ones of the sponsored content providers 110.

Beyond mere listings of sponsored content, the P2P access provider 120 may provide promotional materials, reviews, viewer feedback and/or other information pertaining to particular items of the sponsored content. In particular, as discussed in more detail below, the P2P access provider 120 preferably is provided with financial compensation for viewings of sponsored content files 50 that have been originally downloaded through its site 130. In such cases, the P2P access provider 120 often has a financial incentive to promote sponsored content generally (although not necessarily any particular item of such sponsored content). Accordingly, P2P access provider 120 typically will implement a variety of strategies to steer users to the sponsored-content portion of the site 130 and to download and view such sponsored content.

Nevertheless, users of the site 130 often will not want to be presented with distinctions between sponsored and non-sponsored content, e.g., when viewing a list 137 of the most popular content or when they are searching for specific content. Therefore, with respect to the latter, search window 132 preferably searches across both sponsored and non-sponsored content.

However, even in these cases, the displayed list or the returned search results preferably are visually distinguished from each other. FIG. 5 shows one example of search results across both sponsored and non-sponsored video files. Here, the sponsored files 160 matching the search query are visually distinguished from the matching non-sponsored files 162 in that the sponsored matching files 160 are both listed first and displayed in a different format (here, in italics) than the matching non-sponsored files 162.

If the user desires to display the search results in some other order (e.g., by relevance or date), it is still possible to display the sponsored matching files 160 in a different format in order to visually distinguish them from the matching non-sponsored files 162. Other options to provide such a distinction include using a larger text, displaying in bold versus plain text, displaying in a different font, displaying in a different color, displaying with greater intensity and/or varying any other display characteristic.

It is noted that even without an express bias toward displaying sponsored content to a requesting user, a great deal more information preferably is stored by P2P access provider 120 for the sponsored content than is stored for non-sponsored content, the latter typically being limited to the metadata within the digests 15. As a result, the sponsored content often will be more fully indexed by P2P access provider 120 and, therefore, more likely to be returned as a search result than non-sponsored content.

Returning to FIG. 3, in the present embodiment the sponsored content is made available through an agreement between sponsored content provider 110 and P2P access provider 120. Preferably, sponsored content provider 110 begins with a source video file 112 (potentially obtained from any of multiple different content owners) and modifies it, e.g., to produce a file having the format of the file 50 (shown in FIG. 1). From this file 50, a digest 15 is created, e.g., either by sponsored content provider 110 or P2P access provider 120.

The file 50 preferably is pre-seeded onto a number of devices 142-143 that are configured to participate in a particular peer-to-peer network 140 (often more than 1,000 non-affiliated participants). Such pre-seeding preferably is performed by P2P access provider 120, e.g., in accordance with a minimum download capacity (e.g., minimum 1 megabyte per second) and/or availability capacity (e.g., 24 hours a day, seven days a week with less than 0.1% time downtime) specified by or otherwise on behalf of sponsored content provider 110, with respect to peer-to-peer network 140. In any event, such pre-seeding preferably ensures that there will be sufficient capacity available from the very beginning to accommodate the initial downloading demand.

At the same time, the digest 15 for the sponsored video file 50 preferably is made available to P2P access provider 120. Typically, the digest 15 itself will be stored by P2P access provider 120 so that it can be directly downloaded from the servers of P2P access provider 120. However, in alternate embodiments the digest 15 is stored by another entity (e.g., the entity tracking the sponsored video file 50) with P2P access provider 120 storing just a link to the digest 15. Again, it is noted that P2P access provider 120 need not be the tracker for sponsored video file 50. On the other hand, P2P access provider 120 might want to track sponsored video file 50 itself, given its financial incentive to ensure that sponsored video file 50 is delivered to as many individuals as possible.

In any event, P2P access provider 120 preferably also receives additional information regarding the sponsored content from provider 110. Such information preferably goes well beyond any metadata that might be included within the digests 15, e.g., to include detailed information regarding the genre, actors, writer, director, producer, story and such were shooting location. Still further, P2P access provider 120 can generate additional information pertaining to the sponsored content, e.g., in the nature of promotional material, blogs and the like. All of this information preferably is made available by P2P access provider 120 in the browsing sections 131 of its site 130 and indexed by P2P access provider 120 for the purpose of responding to search queries submitted by users of site 130.

In addition to the sponsored content, P2P access provider 120 provides access to digests 15 pertaining to non-sponsored content, which may be made available to P2P access provider 120 by various individuals and entities 150, such as participants in one or more peer-to-peer filesharing networks (e.g., network 140) and/or by one or more tracker sites. Typically, only the metadata included within such digest 15 is made available for browsing and indexed by P2P access provider 120. As with the sponsored content, the digests 15 for this non-sponsored content may be stored directly by P2P access provider 120, or P2P access provider 120 might simply link to some or all of such digests 15.

As indicated above, P2P access provider 120 preferably has one or more databases 122 storing digests and/or links to digest for both sponsored and non-sponsored content, as well as additional information (preferably mainly or exclusively pertaining to the sponsored content) and one or more indexes of information pertaining to such content and digests.

All of this information preferably is presented and/or made available through site 130. Accordingly, a user of the site 130 is able to locate a particular digest 15 that he or she would like to download through site 130 and then retrieve that digest 15, either directly from P2P access provider 120 or through a link provided by P2P access provider 120. Once the user device 141 has downloaded the digest 15, it can download the corresponding file 10 or 50 across the peer-to-peer filesharing network 140 to which the digest 15 pertains. In the example shown in FIG. 3, the user 41 downloads a sponsored file 50 from devices 142-146 on network 140. It is noted that in addition to the pre-seeded devices 142-143, devices 144-146 previously have downloaded copies of the subject sponsored file 50 and have made them available for access across network 140.

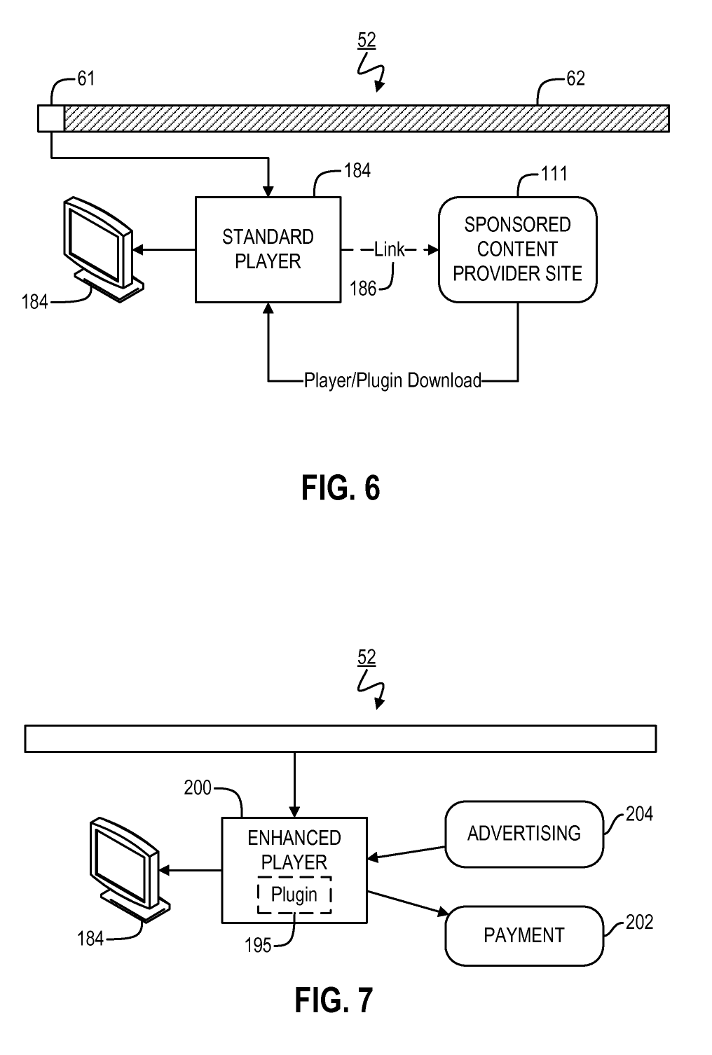

FIG. 6 is a block diagram showing the initial playing of a downloaded video file 50 according to a representative embodiment of the present invention. In the preferred embodiments, the video content 52 includes two parts. A short initial part 61 (preferably 2-4 minutes long, or less than 2-10% of the total length, which typically is 10-120 minutes or even longer) is free of any DRM encoding. The remainder 62 is subject to DRM encoding. As a result, only the initial part 61 is capable of being played (e.g., on an attached monitor 184) through a standard video player 185, such as the Windows Media Player™ or the Apple QuickTime Player™.

Upon completion of the initial part 61, a message preferably is displayed notifying the user that in order to continue playing the rest of the video, a plug-in 195 for the user's existing video player 185 or, in some embodiments, an entirely new player 200 must be downloaded. The message preferably includes a link 186 to a server 111 maintained by the provider 110 that originated the corresponding video file 50, from which the plug-in 195 or entire player 200 can be downloaded. In the preferred embodiments, server 111 provides a site (e.g., website) that provides promotions and information regarding other content that can be searched, browsed, downloaded and/or streamed through sponsored content provider 110. As a result, the user can be exposed to other video available from or through provider 110.

An existing video player 185 with the downloaded plug-in 195 installed also is referred to herein as enhanced video player 200. That is, for most purposes it is irrelevant whether the functionality described herein for enhanced video player 200 is provided by an entirely new player 200 or by a player 185 that has been provided with such functionality through the use of a plug-in 195. Also, it is noted that in certain embodiments of the invention, the initial part 61 of video content 52 is omitted. In these embodiments, the user preferably is required to download the plug-in 195 or entire new player 200 before playing any portion of the video content 52.

In the presently preferred embodiments, in order to leverage existing technology, player 200 is implemented as a commercially available player or players/plug-in combination. For example, the Hyper MP™ player works with Windows machines and does not require a plug-in download prior to viewing the full content. Rather, the Hyper MP™ player itself is embedded into the video file, making the downloaded video file an “executable” file. When using the Hyper MP™ player, ads are streamed live and targeted by the user's IP address. The current version of the Hyper MP™ player does not work while the user is off-line.

The present invention also can use the Hiro Media™ player, which is a multi-platform player (i.e., capable of working on both Windows and Mac computers). In this case, the video files are not “executables” and can be viewed off-line as long as the computer is connected to an Internet connection at least two days prior to viewing the content. The Hiro Media™ player requires a plug-in to be downloaded prior to being able to watch the entire content. Viewers that do not download the plug-in can only watch 3 minutes (or some user-specified period of time) of the downloaded video files. After that period of time, a message appears on the video screen, directing viewers to go to a specified site to download the plug-in, in order to continue watching the downloaded video content.

FIG. 7 is a block diagram showing the playing of the downloaded video file 50 using an enhanced video player 200 according to a representative embodiment of the present invention. As noted above, the enhanced video player 200 can be the original standard video player 185 with a downloaded plug-in 195 installed so as to provide the functionality described herein, or else can be an entirely new video player 200 that has been downloaded and includes such functionality. In either case, the video content 52 is capable of being played by the enhanced video player 200, subject to any conditions or restrictions imposed by the provider 110.

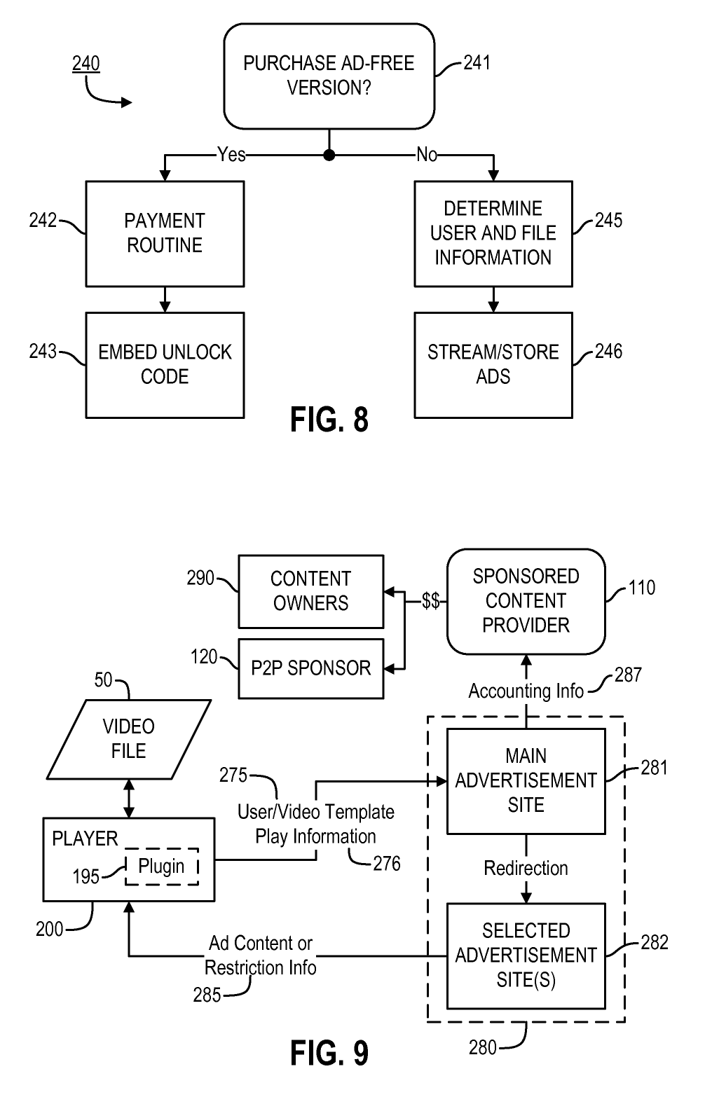

In the preferred embodiments, provider 110 requires that advertisements be displayed along with the video content 52 during its playing and/or that the user pay a license fee to view the video content 52. More preferably, when the user indicates that he or she would like to play a particular video file 50, the enhanced player 200 executes the sequence 240 illustrated in FIG. 8.

As shown in FIG. 8, the enhanced player 200 initially displays a message 241 to the viewer asking whether the viewer would like to watch the video content 52 with advertisements or pay a license fee and view it without any advertisements. If the user indicates that he or she would like to watch the video content 52 without advertisements, then a payment routine 242 is executed in order to obtain a payment 202 from the user.

Payment routine 242 can be executed, e.g., using any conventional techniques, such as a credit card payment, debit card payment, bank account transfer, prepaid account, or the like. In certain embodiments, the user purchases a single viewing, the right to view over some specified period of time (e.g., 24 hours) or even the right to view without any time restriction (each of the foregoing and any other transaction involving payment for viewing being referred to herein as pay-for-view).

However, certain restrictions preferably are imposed in any of these transactions, such as limiting the viewing to a particular geographic region and/or limiting the viewing to a particular player 200 (e.g., with each such player 200 having been assigned a unique identification code). Also, in some embodiments the user can pay different fees for different viewing rights. In any event, upon completion of the transaction, in step 243 an appropriate unlock code is stored in association with the player 200 and/or the video file 50.

On the other hand, if the user declined to pay for the advertisement-free version, then certain user and file information is obtained in step 245, and then advertisements 204 are streamed and/or stored in step 246 based on that information. The user information can include any kind of demographic information (preferably, at least geographic location) pertaining to the user, as well as any other information specific to the user (such as previous video viewing and/or website browsing history), subject to privacy considerations. The file information obtained in step 245 preferably identifies the video content 252 itself, together with any display options, version and/or language format information (such as spoken language and language of any subtitles).

It is noted that the foregoing discussion assumes that it is possible to play the video content 52 on the player 200. However, it often will be the case that a particular video file 50 has geographic restrictions associated with where it can be played (e.g., due to copyright and licensing limitations). Therefore, in such cases, it is preferable to include a step (e.g., even prior to step 241) of verifying that the geographic location of the user is an appropriate playback location prior to permitting any playback of the video content 52. Also, in order to accommodate the possibility that the user will want to watch the video file 50 off-line, the sequence of steps 245-246 can be performed in advance of any request to view the video 50, with the advertisement information being stored in step 246 and then subsequently used when the viewer later requests to watch the video 50.

FIG. 9 illustrates a representative system in which a user plays video content 52 (within video file 50) through a video player 200 according to representative embodiment of the present invention. As noted above, player 200 provides certain functionality that may or may not be provided through a separate plug-in 195. In response to a play request input by the user, or even periodically in the absence of any specific play request, the video player 200 provides certain information 275 regarding the user and video file 50 to an advertisement system 280 that includes one or more advertisement servers, e.g., servers 281-282.

In the present embodiment, the advertisement system 280 includes a main advertisement server 281 that evaluates the user and video information 275 and identifies an appropriate specialized advertisement server 282 to deliver advertisements with respect to the requested or anticipated playing of video file 50. Thus, for example, one advertisement server 282 might be identified for a Spanish-language video being played in Spain, while a different advertisement server 282 is identified for the same Spanish-language video being played in Southern California, and a still different advertisement server 282 is identified for the same video played in Southern California in English.

Although the selection of server 282 preferably is made on the basis of a provided language-and-geographic-location template, in certain embodiments other characteristic information regarding the video file 50 (e.g., genre) and other demographic or personal information regarding the user also may be provided by player 200 and/or taken into consideration by advertisement server 281. Also, rather than (or in addition to) the player 200 indicating its own geographic location, advertisement server 281 may identify the geographic location of the player 200, e.g., based on the Internet Protocol (IP) address of the device on which player 200 resides (assuming player 200 communicates with advertisement server 281 over the Internet).

Information 275 also may indicate geographic license restrictions pertaining to where the video file 50 can be played or, alternatively, such information can be retrieved by advertisement server 281 (or another server associated with sponsored content provider 110) based on an identification of the particular video file 50 (the latter being preferable where it is anticipated that license rights might change over time). Advertisement server 281 (or such other server) preferably provides any such restriction information, together with advertisement template information included in information 275, to the selected advertisement server 282 (or directly to player 200).

Server 282 then transmits information 285 indicating any restrictions on the playing of the current video file 50 or, if none, advertisement content to be displayed along with the video content 52 in file 50. If the current interaction is pursuant to a user request to play the video content 52, then such advertisement content preferably is streamed in real-time and/or buffered by player 200. On the other hand, if the current interaction is pursuant to a periodic update, then the advertisement content preferably is simply transferred to player 200 to be stored for later display with the video content 52.

In this regard, player 200 preferably is configured such that any particular video file 50 can only be played if player 200 currently is connected to the Internet, has a currently valid unlock code available, or has downloaded advertisement content for the video 50 within a maximum specified period of time (e.g., not more than two days or one week) prior to the play request.

For any video file 50 that is played with advertisements, player 200 preferably provides video-play information 276 indicating the number of times the video 50 has been played, or some other indication of the playing history of the video file 50 (e.g., number of minutes played or a listing of the advertisement content displayed while the video file 50 was playing). Site 281 then provides this information 276, together with any information regarding pay-for-view payments with respect to the video 50, as accounting information 287, to the corresponding sponsored content provider 110.

Accounting information 287 is then used by provider 110 to make payments to the appropriate entities. For example, in the preferred embodiments of the invention, the P2P access provider 120 is paid a fixed percentage of any revenues (e.g., advertisement revenues and pay-for-play fees) generated from any files 50 that originated from a download promoted from its site 130 (e.g., as determined by the sponsoring site identification information 56 embedded in the file 50), at least for the period of time that the site 130 continues to promote the video file 50 and, potentially, for some specified period of time thereafter. In addition, it usually will be the case that the sponsored content provider 110 obtains rights to the source video file 112 (and to generate the file 50) from another entity (referred to herein as the content owner). Thus, in the preferred embodiments, the P2P access provider 120 also pays a fixed percentage of any revenues generated from their provided content to the appropriate content owners 290.

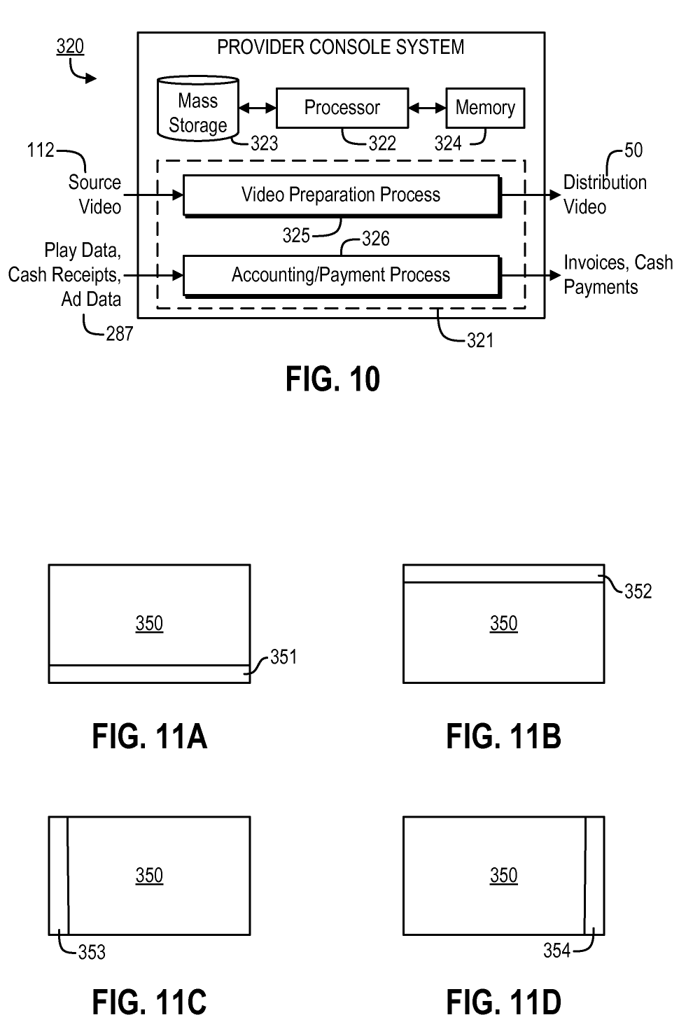

FIG. 10 is a block diagram of a management console system 320 used by sponsored content provider 110 in a representative embodiment of the present invention. Typically, system 320 is implemented using one or more general-purpose computers and, therefore, has at least one digital computer processor 322 and one or more storage devices, such as hard drive or other mass storage device 323 and memory 324, although any other architecture described herein instead may be used. In the present embodiment, processor 322 performs certain processes by reading and executing computer-executable process steps from at least one of the storage device 323 and 324. Such processes preferably include a management console application 321 which, in turn, includes a video preparation process 325 and an accounting/payment process 326.

Several different commercial management console applications exist and can be used for management console application 321. In particular, each commercially provided player typically is paired with a corresponding management console. Accordingly, in the present embodiment, it is preferred to use the management console corresponding to the selected player (e.g., Hiro Media™ or Hyper MP™).

As indicated above, the main input into video preparation process 325 is a source video 112, and the main output is a distribution video 50. The video preparation process 325 allows the sponsored content provider 110 to insert information into the original file 112. In the present embodiment, one element of such information is identification information 56 for the P2P access provider 120 that will be sponsoring or promoting the video 50. In certain embodiments, information 56 includes a separate code for the P2P access provider 120. In other embodiments, information 56 and other information is combined into a single code. As to the latter case, for example, a single code might identify the video title and the P2P access provider 120, with different codes for different title-provider pairs, using a lookup table to determine the relevant information from any individual code.

If the video content 52 is not appropriately compressed in the source file 112, then video preparation process 325 may also perform such compression. However, typically other hardware and/or software will be used to compress the video content 52, often with the actual compression services being performed by a separate entity.

Another function of video preparation process 325 is to allow the sponsored content provider 110 to design and embed the advertisement information 58 (which, again, need not necessarily be included within video file 50, but at least preferably is stored, e.g., by player 200 or a server associated with sponsored content provider 110 in association with the video file 50). In the preferred embodiments, such information 58 includes an advertisement template describing where, when and how advertisements are to be displayed during the playing of the video content 52. A variety of different types of advertisements are possible, including pre-roll (e.g., commercials played on the entire video screen prior to the beginning of video content 52), in-stream (e.g., commercials played on the entire video screen in between segments of video content 52), post-roll (e.g., commercials played on the entire video screen following the end of video content 52), banner ads (e.g., displayed on some portion of the user interface for player 200 other than the actual video screen), overlays (advertisements displayed on top of some portion of the video content 52) and contextual advertisements (e.g., products or services that are shown in the video content 52, particularly active placements that allow the user to link to, otherwise obtain additional information about, or purchase the depicted item or service).

Overlay advertisements currently are preferred because they are the most difficult for pirates to extract in an attempt to create a “clean”, DRM-free version of the video content 52. FIGS. 11A-D illustrate a display portion 350 of the user interface for designating overlay advertisements templates through the video preparation process 325 according to a representative embodiment of the present invention. Specifically, as the video 50 is being viewed, the user is able to designate a strip or band (e.g., by clicking on the desired strip) along any of the four edges of the video display, i.e., strip 351 along the bottom edge, strip 352 along the top edge, strip 353 along the left edge, or strip 354 along the right edge. Then, while the video continues to play, the user clicks a “start” button to indicate that the designated strip is to be active and then a “stop” button to indicate that the designated strip is to be inactive. For the specified duration of time that a particular strip is active, an advertisement is capable of being displayed in it. Thereafter, the designated time blocks for each strip can be subdivided into standard fixed-length blocks (e.g., 15 or 30 seconds) that are to be marketed, e.g., with the video preparation process 325 prompting the user to extend or shorten the designated time block if there remains a non-standard-length block after such initial subdivision.

In a similar manner, any other kinds of advertisements (e.g., any of the kinds mentioned above) may be specified. For example, an in-stream advertisement can be specified by simply clicking on an “insert instream ad” button at the desired point in the video and specifying a duration for the advertisement. Banner advertisements, if to be provided, often can be displayed at any point during the playing of the video content 52. However, if it is determined that there are prime-time intervals during the playing of the video content 52 (which can command a higher advertising rate), those intervals can be specified in the same manner as overlay advertisements (e.g., as described above). Contextual advertisements can be designated by selecting items or regions in the video (e.g., by pointing and clicking) and then selecting individual merchants and/or categories of products and/or services (e.g., from a drop-down menu) for which advertisements may be attached.

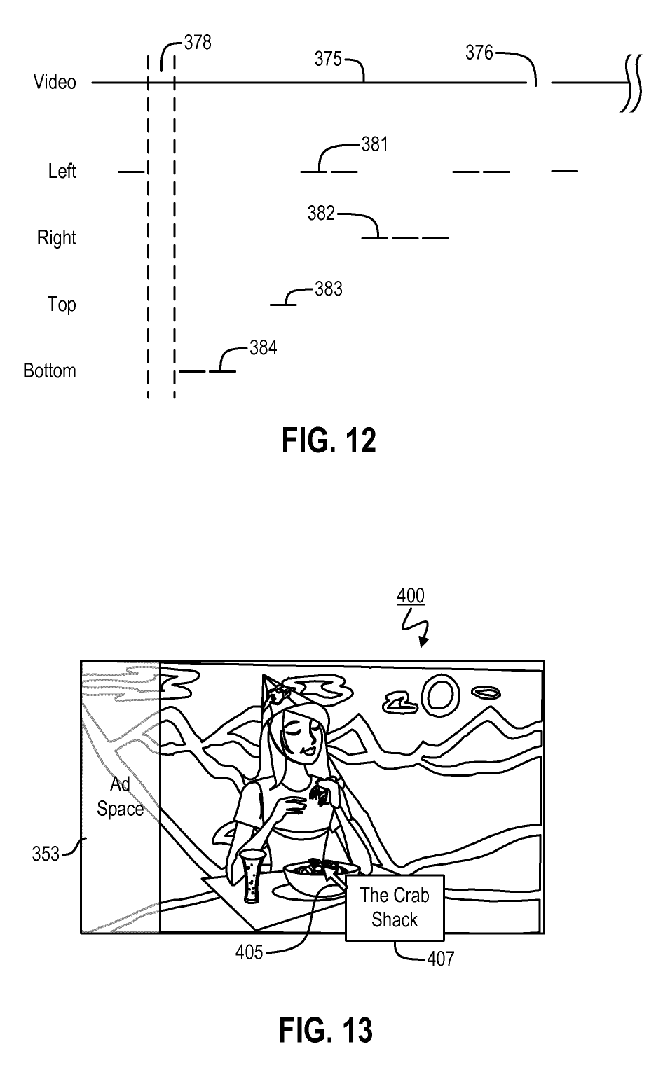

An example of a resulting advertisement template is shown in FIG. 12. In this example, the video timeline 375 indicates when the video content 52 is playing, with break 376 indicating a pause for the displaying of an instream advertisement. Timelines 381-384 show the intervals during which the bottom, top, left and right strips 351-354, respectively, have been designated, divided into fixed (e.g., 30-second) blocks for selling to advertisers. In the present example, only a single one of the strips 351-354 can be designated at a time. However, in other embodiments, multiple strips can be designated simultaneously.

In still further embodiments, only a single strip or other portion of the video display area 350 is available for such overlay advertisements. However, having the ability to designate any of multiple different regions within display area 350 often can provide greater flexibility, because the sponsored content provider 110 often will not want to obscure some important part of the video scene. Also, any other technique may be used for advertising and/or for designating advertisement templates, such as any of the techniques used in any of the existing management consoles.

It is noted that there are some portions of the timeline 375 during which video content 52 is being played, such as during interval 378, where no overlay advertisements are scheduled. This can be, e.g., because the entire video frame includes important visual information which should not be obscured or because there is too much action occurring that it is unlikely that a viewer would pay any significant attention to such advertisements. On the other hand, it is also possible to schedule overlay advertisements during either such type of time interval, although in such cases it is preferable to charge a lower advertisement rate based on the expectation that the viewers will pay less attention to advertisements during such time intervals.

FIG. 13 illustrates a single frame of video content 52 being played back, with advertisements inserted into a previously designed template. Here, the left-edge strip 353 has been designated for this particular point in time, so advertisements may be displayed there. As shown, the designated strip preferably is partially see-through, so as not to completely obscure the portion of the video frame that it overlays. Also, because strip 353 is vertically oriented, different kinds of advertisements may be more appropriate for it than when one of the horizontally oriented strips 351 or 352 has been designated.

Frame 400 also has contextual advertisements designated within it. For example, the illustrated food previously (e.g., using video preparation process 325) has been marked and associated with the category seafood restaurants, and advertisement system 280 has supplied the name of a local seafood restaurant based on this information and based on the identified geographic location of the video player 200, so that when the viewer hovers his or her cursor 405 over the food, a pop-up box 407 containing information identifying the local seafood restaurant is displayed. In addition, clicking with the cursor 405 in this position of the frame 400 preferably pauses the playing of the video content 52 and opens the webpage for the identified local seafood restaurant.

Returning to FIG. 10, the accounting/payment process 326 receives (e.g., via the Internet) accounting information 287, such as data pertaining to video-playing history and cash receipts, segregated by individual video file 50, as well as advertisement placement and/or response data. From this information and pre-stored information regarding required (e.g., contractual) divisions of net revenues, accounting/payment process 326 periodically (e.g., monthly or quarterly) calculates the fees due to be paid to the various content owners 290 and to P2P access providers 120, and then issues the appropriate checks (or transfers the required funds electronically). Similarly, accounting/payment process 326 issues invoices to its advertisers based on the number and/or types of impressions provided and/or based on viewer responses (e.g., click-throughs).

In the preferred embodiments, a separate server (not shown) operated by or on behalf of sponsored content provider 110 handles receipt of the payments for pay-for-view transactions and the corresponding disbursement of purchase to unlock codes. That server then forwards the received cash to sponsored content provider 110 and corresponding accounting information to accounting/payment process 326.

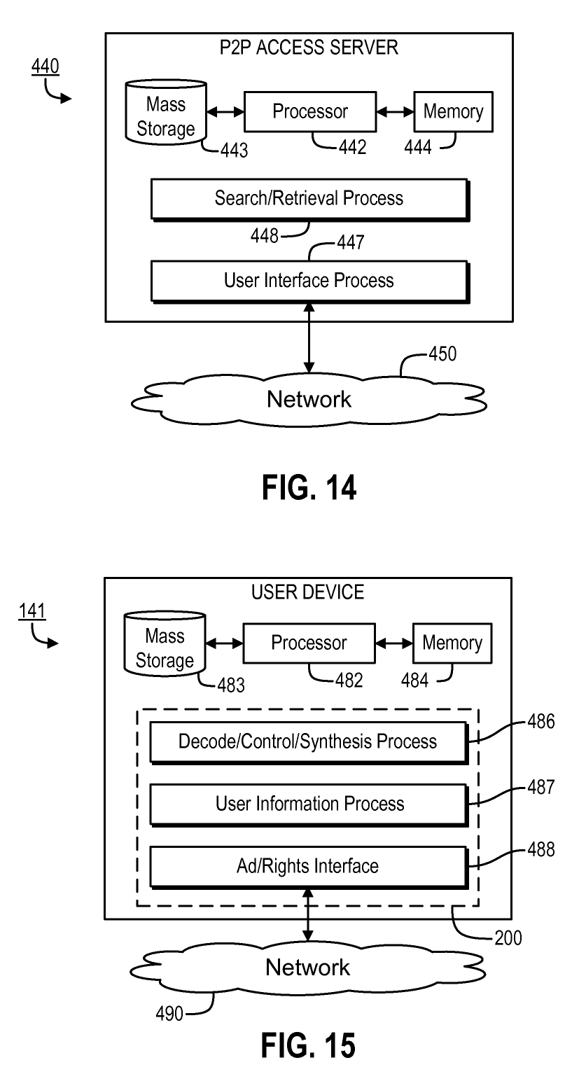

FIG. 14 is a block diagram of a server 440 used by P2P access provider 120 in a representative embodiment of the present invention. Preferably, server 440 is implemented using one or more general-purpose computing devices and, therefore, has at least one digital computer processor 442 and multiple storage devices, such as hard drive or other mass storage device 443 (which typically stores, in addition to computer program instructions, the entire database of digests 15, links to such digests and related information) and memory 444, although any other architecture described herein instead may be used. In the present embodiment, processor 442 performs certain processes by reading and executing computer-executable process steps from at least one of the storage device 443 and 444. Such processes preferably include a user interface process 447 and a search/retrieval process 448.

In the preferred embodiments, user interface process 447 provides the site 130, which typically is a website, on a publicly accessible network 450, such as the Internet. Software for providing such a site is well known in the art and, therefore, is not discussed in detail here.

Search/retrieval process 448 maintains the database of information pertaining to digests 15 that are accessible through site 130 and processes any search queries submitted through site 130. For this purpose, process 448 preferably continuously indexes all information pertaining to such digests 15.

FIG. 15 is a block diagram of a device 141 used by a participant to communicate across a peer-to-peer filesharing network 140 and to interact with P2P access provider 120 according to a representative embodiment of the present invention. Ordinarily, device 141 is implemented as a desktop or laptop computer and, therefore, has at least one digital computer processor 482 and multiple storage devices, such as hard drive or other mass storage device 483 and memory 484, although any other architecture described herein (e.g., a wireless phone) instead may be used for device 141. In the present embodiment, processor 442 performs certain processes by reading and executing computer-executable process steps from at least one of the storage device 483 and 484. Such processes preferably include, in addition to other software such as a Web browser client, video player 200. As shown, the player 200 preferably includes a decode/control/synthesis process 486, a user information process 487 and an ad/rights interface 488.

Decode/control/synthesis process 486 provides the main functionality of player 200, decoding the DRM-encoded aspects of the video content 52, controlling the playing of such content 52, and synthesizing the video content 52 together with other information, such as the pre-stored or streamed advertisement content. As indicated above, any existing or future-developed DRM technique can be used to prevent playing of the video content 52 except through a player 200 having the corresponding decoder (which decoding preferably is implemented only in conjunction with advertisement insertion as described herein or through purchase of a pay-for-view unlock code). The control aspects of decode/control/synthesis process 486 preferably allow a viewer to start, stop, pause and, in some cases, fast-forward, skip forward, fast review and/or skip backward.

The synthesis aspect preferably involves merging video streams (e.g., after they have been rasterized by the player 200). For example, with respect to overlay advertisements, the advertisement content (e.g., its pixel values), either just the substantive portion of such content or its background as well, can completely replace the underlying video content 52 within the advertisement region. However, in certain embodiments the pixel values of the advertisement content, again either just the substantive portion of such content or its background as well, are combined with the pixel values for the advertisement content 52 on a weighted-average basis (e.g., with greater weight given to the advertisement content), so that the video content 52 within the region remains viewable, although somewhat attenuated. In a hybrid approach, the substantive content of the advertisements replaces the video content 52, and the background for the advertisement is combined with the video content 52 (or the video content 52 is simply attenuated in intensity within the entire region in which the advertisement content is displayed).

In any event, in the current embodiments the overly advertisements are displayed as flash video. Thus, for example, where the edge bands 351-354 described above are used, the advertisements can roll across (for horizontally oriented bands) or roll up (for vertically oriented bands) the designated regions.

In a similar manner, the decode/control/synthesis process 486 also associates any streamed or pre-stored advertisement content (e.g., rollover pop-up text or hyperlinks) with any contextual advertisements specified in the advertisement template.

User information process 487 collects and stores information pertaining to the user of the device 141. Typically, one of the main items of information (both for controlling playing a video content 52 in accordance with licensed rights and for advertisement purposes) is the geographic location of the device 141. This information can be obtained, e.g., by recording the IP address assigned to the device 141 when browsing the Internet, by requesting that the user provide such information and/or by monitoring any other activity that is indicative of geographic location, all subject to privacy considerations. Similar monitoring can be used to obtain other demographic and/or personal pertaining to the user (mainly for advertising purposes).

Ad/rights interface 488 communicates with advertisement server(s) 280 and/or other external servers via publicly accessible network 490 (e.g., the Internet), providing a user interface through which the viewer can purchase limited or unlimited unlock keys so that the user can purchase pay-for-play viewings (e.g., advertisement-free) and receiving advertisement content in accordance with the advertisement template. Any such received advertisement content preferably is stored, e.g., in mass storage device 483 within the video file 50 as part of the advertisement information 58 or in a separate file that is associated with video file 50, and time stamped. As indicated above, the player 200 preferably is configured so as to only play a video file 50 if a valid unlock code has been obtained, if it currently is connected to a network 490 so that advertisement content can be streamed, or if previously stored advertisement content is less than a specified maximum age (e.g., not more than two days old).

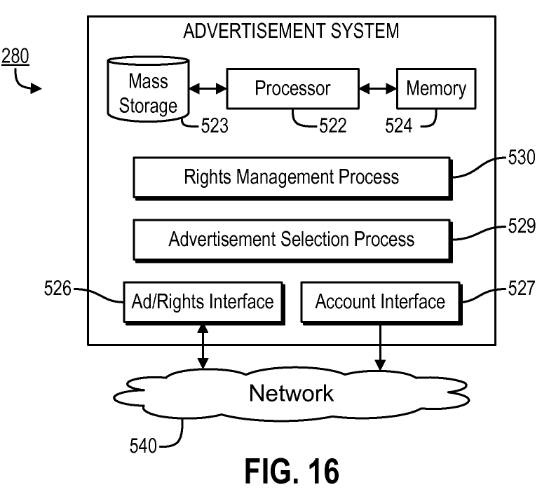

FIG. 16 is a block diagram of advertisement system 280 according to a representative embodiment of the present invention. As noted above, system 280 can be implemented using one or more server boxes or clusters and often will include cooperating entities having servers that are geographically distant from each other. In any event, system 280 preferably includes at least one digital computer processor 522 and multiple storage devices, such as hard drive or other mass storage device 523 (e.g., storing advertisement content and a database of advertisement templates for the individual video files 50) and memory 524, although any other architecture described herein (e.g., a wireless phone) instead may be used for system 280. In the present embodiment, processor 522 performs certain processes by reading and executing computer-executable process steps from at least one of the storage device 523 and 524. Such processes preferably include an ad/rights interface 526, an account interface 527, an advertisement selection process 529 and a rights management process 530.

Ad/rights interface 526 communicates with video players 200 in individual user devices 141, and account interface 527 communicates with provider console systems 320, via one or more networks 540 (e.g., the Internet). In the present embodiment, the advertisement system 280 provides advertisements and manages the purchase and sale of pay-for-view unlock codes through ad/rights interface 526. Accordingly, interface 526 can be configured to implement a website or similar site for accepting payment and can communicate advertisement content using TCP/IP (Transmission Control Protocol/Internet Protocol). Account interface 527 provides accounting information regarding cash receipts and displayed advertisement content (e.g., using TCP/IP) to the applicable console application 321 that provided the video files 50 to which such information pertains.

Advertisement selection process 529 preferably executes a straightforward process of supplying advertisement content to fill in the advertisement template for the current video file 50. As noted above, the template preferably includes time blocks to be filled and/or identification of categories and/or specific businesses for particular purposes. At the same time, the process 529 preferably receives at least geographic information pertaining to the user (e.g., within a communication from the device 141 or from the IP address that device 141 is using in its communications with interface 526). Based on these criteria and the language information pertaining to the video content 52, advertisement content is selected.

In many cases, language is one of the most important considerations. Once the user's language is identified, all advertisement preferably is delivered in the language that has been identified for the viewer. In addition, geographic location, as well as indicating what kinds of local advertisements are desirable, may indicate particular dialects that should be observed. For this reason, as noted above, different advertisement servers are used for different geographic/language combinations, with each such server preferably having specialized knowledge of the population speaking the identified language in the identified territory. Secondarily, other demographic and/or personal information often can be used to target advertisements more effectively. To the extent advertisements for local establishments are available, they can be presented. Otherwise, advertisements for national or international enterprises (provided they are in the correct language) can be provided. The advertisement template itself either can be provided to system 280 over network 540 or can be pre-stored (e.g., in mass storage device 523) and retrieved based on an identifier for the video file 50.

Rights management process 530 determines whether the rights associated with the video file 50 (stored in mass storage device 523) allow the video file 50 to be played at the identified geographic location identified for device 141. If not, process 530 causes a message to be sent (through interface 526) instructing the player 200 in device 141 to block playing of the video file 50.

In the embodiments described above, the system 100 is structured such that advertisement content must be fairly current (e.g., within two days old) for the video file 50 to be played. As result, the enhanced video player 200 downloads different selected advertisements over time, so that different playings of the same video file 50 can include different advertisements during the same specified blocks of time. In such a case, irrespective of how long a particular video file 50 has been in circulation, the advertisements continue to remain current.

In the preferred embodiments, a P2P access provider 120 is used to leverage the power of peer-to-peer filesharing networks 140 to both distribute video content and to steer users to a site maintained by sponsored content provider 110. In addition, other mechanisms can be used to steer users to such a site, such as the placement of a permanent link to content provider 110's site on the player 200 and/or the placement within the video itself (e.g., at the beginning, middle or end of the video) of: thumbnails for other videos functioning as links to those videos on content provider 110's site, various other kinds of links and/or shortcuts that open an e-mail message or other electronic message (which can be sent to any other individual that the current user chooses) with an embedded link to the current video on content provider 110's site.

Finally, it is noted that the discussion above pertains primarily to distribution of video content. However, it should be noted that such systems, methods, techniques and apparatuses also can be used to facilitate the distribution of other kinds of files. Examples include audio files, software files, image files, game files and the like.

### System Environment.

Generally speaking, except where clearly indicated otherwise, all of the systems, methods, functionality and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., the hard disk), are downloaded into RAM and then are executed by the CPU out of RAM. However, in some cases the process steps initially are stored in RAM or ROM.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, workstations, personal computers and/or even smaller computers, such as PDAs, wireless telephones or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these, with the particular implementation being selected based on known engineering tradeoffs. More specifically, where any process and/or functionality described above is implemented in a fixed, predetermined and/or logical manner, it can be accomplished by a general-purpose processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible media on which are stored software or firmware program instructions (i.e., computer-executable process instructions) for performing the methods and functionality of this invention. Such media include, by way of example, magnetic disks, magnetic tape, optically readable media such as CD ROMs and DVD ROMs, or semiconductor memory such as PCMCIA cards, various types of memory cards, USB memory devices, etc. In each case, the medium may take the form of a portable item such as a miniature disk drive or a small disk, diskette, cassette, cartridge, card, stick etc., or it may take the form of a relatively larger or immobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server device, computer-readable medium or other storage device, client device, or any other kind of device, such references should be understood as encompassing the use of plural such processors, computers, server devices, computer-readable media or other storage devices, client devices, or any other devices, except to the extent clearly indicated otherwise. For instance, a server generally can be implemented using a single device or a cluster of server devices (either local or geographically dispersed), e.g., with appropriate load balancing.

### Additional Considerations.

In certain instances, the foregoing description refers to clicking or double-clicking on user-interface buttons, dragging user-interface items, or otherwise entering commands or information via a particular user-interface mechanism and/or in a particular manner. All of such references are intended to be exemplary only, it being understood that the present invention encompasses entry of the corresponding commands or information by a user in any other manner using the same or any other user-interface mechanism. In addition, or instead, such commands or information may be input by an automated (e.g., computer-executed) process.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A system for facilitating the distribution of video content, comprising:
a data-storage device storing computer-executable process steps and data, with:
the data including at least one of (i) a plurality of file digests and (ii) a plurality of links to file digests that are located on at least one remote unaffiliated server, the file digests containing information for downloading corresponding files using at least one peer-to-peer network, the corresponding files including both restricted-access sponsored video files and unrestricted files, and the unrestricted files having made available by different participants in at least one peer-to-peer network; and
a processor coupled to the data-storage device and configured to execute the process steps, with the process steps comprising steps to provide, at a network address on a publicly accessible network, an access site that allows users to locate and download the file digests,
wherein the file digests for the restricted-access sponsored video files are separately visually designated as such on the access site, and
wherein each of the restricted-access sponsored video files includes an identification of an operator of the site.

2. A system according to claim 1, wherein the file digests for the restricted-access sponsored video files are included on a separate page of the site.

3. A system according to claim 1, wherein the file digests for the restricted-access sponsored video files are visually differentiated from the unrestricted files when both are returned as search results on the access site.

4. A system according to claim 1, wherein playing any one of the restricted-access sponsored video files in its entirety requires an enhanced video player that at least one of: (1) displays advertisements when playing said one of the restricted-access sponsored video files or (2) requires payment in order to play said one of the restricted-access sponsored video files.

5. A system according to claim 4, wherein the restricted-access sponsored video files are configured so as to be able to play for a specified period of time on an unrestricted basis on a standard video player.

6. A system according to claim 4, wherein the enhanced video player gives a user a choice of either said option (1) or said option (2).

7. A system according to claim 4, wherein said one of the restricted-access sponsored video files includes, in addition to video content, an advertisement template that identifies blocks of time during a playing of the video content when advertisements can be displayed, and wherein the enhanced video player downloads selected advertisements and overlays the selected advertisements onto a portion of the video content during the specified blocks of time while the video content is playing.

8. A system according to claim 7, wherein the enhanced video player overlays the selected advertisements onto a band along an edge of the video content.

9. A system according to claim 7, wherein the enhanced video player downloads different selected advertisements over time so that different playings of said one of the restricted-access sponsored video files include different advertisements during the same specified blocks of time.

10. A system according to claim 9, wherein the enhanced video player downloads the selected advertisements in advance and stores them in association with the video content.

11. A system according to claim 7, wherein the selected advertisements are based on both an identified geographic location of the enhanced video player and a language format of the video content.

12. A system according to claim 11, wherein the identified geographic location is determined from an Internet Protocol address of a device on which the enhanced video player resides.

13. A system according to claim 4, wherein the enhanced video player uploads information regarding playing history, linked to the identification included in the restricted-access sponsored video files, to a computer affiliated with a provider of the restricted-access sponsored video files, and wherein the provider transmits payment to the operator of the site based on the playing history information.

14. A system according to claim 1, wherein the operator of the site has pre-seeded the restricted-access sponsored video files onto computers on the at least one peer-to-peer network.

15. A system according to claim 1, wherein the unrestricted files have been made available by at least 1,000 participants in at least one peer-to-peer network

16. A system according to claim 1, wherein the file digests comprise torrent files for a bit torrent peer-to-peer network.

17. A system according to claim 1, wherein the site is provided on the Internet.
